(19) United States
(12) Patent Application Publication
(10) Pub. No.: US 2011/0075446 A1
(43) Pub. Date: Mar. 31, 2011

(54) Circuit for Converting a Pulsed Input Voltage to a DC Voltage

(75) Inventors: Jan Doutreloigne, Deinze (BE); Benoit Bakeroot, Gent (BE); Stefaan Maeyaert, Knokke-Heist (BE); Vincent De Gezelle, Assebroek (BE)

(73) Assignees: IMEC, Leuven (BE); UNIVERSITEIT GENT, Gent (BE)

(21) Appl. No.: 12/895,154

(22) Filed: Sep. 30, 2010

Related U.S. Application Data
(60) Provisional application No. 61/247,299, filed on Sep. 30, 2009.

(30) Foreign Application Priority Data
Jan. 29, 2010 (EP) 10152116.9

(51) Int. Cl. H02M 3/315

(52) U.S. Cl. 363/15

(57) ABSTRACT

The present disclosure presents a circuit for converting a pulsed input voltage to a DC output voltage. The circuit comprises input nodes for receiving the pulsed input voltage and output nodes for outputting the DC output voltage. The circuit further comprises a first transistor and a second transistor connected between the input and the output nodes in a synchronous rectifier configuration. The first and second transistors each have a gate connected to a driving circuit configured for alternately charging the gates of the transistors whereby the driving circuit comprises an auxiliary circuit not directly connected to the input nodes and configured for providing a predetermined auxiliary supply voltage to the gates. In an embodiment, the auxiliary circuit comprises a buck DC-DC converter of which an input node is connected to the output nodes and of which an output node is connected to the gates.

### CROSS-REFERENCE TO RELATED APPLICATIONS

This application claims priority to U.S. Provisional Application Ser. No. 61/247,299 filed Sep. 30, 2009 and European Patent Application No. 10152116.9 filed Jan. 29, 2010. The contents of U.S. Provisional Application Ser. No. 61/247,299 and European Patent Application No. 10152116.9 are incorporated by reference herein in their entirety.

### FIELD

The present invention relates to a circuit for converting an input voltage into an output voltage. In particular, the invention relates to a rectifier in a voltage converter.

### BACKGROUND

FIG. 1 depicts a typical isolated forward DC-DC converter. As shown in FIG. 1, typical isolated forward DC-DC converters contain a synchronous rectifier at the output of the pulse transformer 1 for the conversion of the pulsed AC signal into a stable DC output voltage. The two power double-diffused metal-oxide-semiconductor (DMOS) transistors 2, 3 in the synchronous rectifier act like almost-ideal rectifying diodes with a very small forward voltage drop, thereby exhibiting much lower static power dissipation than standard p-n junction diodes. For charging and discharging the gate capacitance of the DMOS devices (to switch them on or off), an auxiliary circuit 4 is included in the system.

As shown, auxiliary circuit 4 contains a bipolar transistor and a Zener diode that charge the gate capacitance of the DMOS device to a fixed voltage level (determined by the Zener voltage) directly from the output node of the pulse transformer 1. As the DMOS already reaches its minimum on-state resistance as soon as the gate voltage is slightly above threshold (for very low drain voltages), the Zener voltage can be kept very low (typically a few volts), while the output voltage of the transformer 1 is rather high (typically tens of volts).

This means that the DMOS gate electrode is charged to a low voltage from a much higher voltage source. Calculations show that this is a very power-inefficient way of charging a capacitor, and it results in considerable dynamic power losses in the bipolar transistors especially at very high switching frequencies.

A second problem is encountered when the gate electrodes of the two power DMOS transistors 2, 3 are being discharged to switch them off. This is done through a standard p-n junction diode, resulting in a residual voltage of approximately 0.4V on the gate electrode. This residual voltage is not a problem in a discrete version of the synchronous rectifier as the DMOS devices have a sufficiently high threshold voltage, but when aiming at monolithic integration in an advanced smart-power IC technology where the DMOS devices normally have a threshold voltage only slightly above 0.4V, this residual gate voltage results in a non-negligible sub-threshold current. Since the voltage drop between source and drain in this off-state is several tens of volts while it's extremely small (below 100 mV) in the on-state, this sub-threshold current represents a static power dissipation in the off-state that is comparable to the static power dissipation in the on-state. This is of course a significant waste of energy and reduces the overall power efficiency considerably.

### SUMMARY

The present disclosure is directed to a circuit for converting a pulsed input voltage to a DC output voltage. The circuit comprises at least two input nodes arranged to receive a pulsed input voltage and at least two output nodes arranged to output a DC output voltage. Additionally, the circuit comprises a first transistor having a first gate and a second transistor having a second gate. Each of the first transistor and the second transistor is connected between the at least two input nodes and the at least two output nodes. For example, the first transistor and the second transistor may be connected between the input and the output nodes in a synchronous rectifier configuration, meaning the first and second transistors may each be connected in parallel with a diode.

In an embodiment, the first gate and the second gate may each be grounded via at least one gate discharging transistor. In particular, the at least one gate discharging transistor comprises a first gate discharging transistor controlled by the first transistor and operable to discharge the second gate. The at least one gate discharging transistor may additionally comprise a second gate discharging transistor controlled by the second transistor and operable to discharge the first gate. In an embodiment, discharging the second gate comprises discharging the second gate during an off-state of the second transistor, and discharging the first gate comprises discharging the first gate during an off-state of the firs transistor. In an embodiment, the gate discharging transistors may be driven by a buffer (e.g., one or more inverters). By discharging the gates of the transistors (or removing residual voltage during switch-off) the overall power efficiency can be improved.

The circuit additionally comprises a driving circuit connected to the first gate and the second gate. The driving circuit is arranged to alternately charge the first gate and the second gate. The driving circuit may comprise an auxiliary circuit arranged to provide a predetermined auxiliary supply voltage to the first gate and the second gate. By charging the gate capacitance of the transistors via the auxiliary supply voltage, a more optimal voltage for charging the gates can be selected, thereby reducing dynamic power losses in the transistors.

In an embodiment, the first and second transistors may each have a threshold voltage. In an embodiment, the predetermined auxiliary supply voltage may be between 2 and 10 times the threshold voltage.

In an embodiment, the auxiliary circuit may comprise an auxiliary output node connected to the first gate and the second gate. In an embodiment, the auxiliary circuit may not be directly connected to the at least two inputs. That is, the auxiliary circuit may not be immediately powered by the pulsed input voltage, but rather may have another power source. The auxiliary circuit may instead be powered by an independent power source, or the auxiliary circuit may be powered by the output voltage. In an embodiment, the auxiliary circuit may comprise an auxiliary input node connected to the at least two output nodes, so as to be powered by the output voltage. While the auxiliary circuit is connected to the at least two output nodes, the auxiliary circuit is still not directly connected to the at least two input nodes, as there is at least one circuit component between the auxiliary circuit and the at least two input nodes.

The auxiliary circuit may be a buck DC-DC converter, which typically have high efficiency. Other types of converters are also possible. The first and second transistors may be double-diffused metal-oxide-semiconductor (DMOS) transistors, which are also typically both fast and efficient. Other types of transistors (e.g. bipolar) are also possible.

In an embodiment, the circuit may further comprise a control block operable to control the auxiliary supply voltage based on at least one input parameter, such as current, frequency, and temperature.

In an embodiment, the circuit may further comprise a back-up circuit operable to power on the auxiliary circuit at start-up.

The circuit may, in some embodiments, be integrated in a voltage converter. In an embodiment, the voltage converter comprises a primary circuit arranged to receive a first voltage and a secondary circuit arranged to receive a pulsed input voltage. The secondary circuit may comprise a first transistor having a first gate and a second transistor having a second gate.

The voltage converter may additionally comprise a pulse transformer comprising a primary winding and a second winding. The primary winding may be connected to the primary circuit, and the secondary winding may be connected to the secondary circuit. In an embodiment, the secondary winding may be connected to the secondary circuit via at least two input nodes, as described above.

The pulse transformer may be operable to transform the first voltage into the pulsed input voltage. That is, the pulse transformer and the primary circuit together may transform the first voltage into a pulsed voltage, and the secondary circuit may form the DC output voltage from the pulsed voltage.

The voltage converter may additionally comprise a driving circuit connected to the first gate and the second gate. The driving circuit may be arranged to alternately charge the first gate and the second gate by means of an auxiliary supply voltage.

In an embodiment, the first voltage a DC voltage that is a higher voltage than the DC output voltage. In an example, the voltage converter circuit is provided for converting a DC voltage of around 36-72 V as the first voltage into a DC voltage within the range of 1 to 12 V as the output voltage.

Alternately, the first voltage may be an AC voltage. In an embodiment, the primary circuit and the secondary circuit may be monolithic integrated circuits.

### BRIEF DESCRIPTION OF THE DRAWINGS

The invention will be further elucidated by means of the following description and the appended figures.

FIG. 1 shows a prior art synchronous rectifier.

FIG. 2 shows a version of a synchronous rectifier according to an embodiment of the invention.

FIG. 3 illustrates the principle of dynamic power loss reduction.

FIG. 4 shows a power-on backup circuit.

FIG. 5 illustrates an embodiment of a synchronous rectifier with reduced dynamic power losses and suppressed sub-threshold conduction according to the invention.

FIG. 6 shows a schematic of a vertical DMOS.

FIG. 7 illustrates a typical output voltage of the synchronous rectifier after start-up.

FIG. 8 shows simulation results of the (a) source-gate voltage, (b) source-drain voltage and (c) the drain current at 1 MHz for M=400.

FIG. 9 shows a plot of the power efficiency of the synchronous rectifier of FIG. 1 for different chip sizes and switching frequencies.

FIG. 10 shows a schematic of a 12V to 4V buck converter.

FIG. 11 illustrates the impact of nDMOS sub-threshold conduction on the power dissipation at 200 kHz for M=800.

FIG. 12 shows a simulation of effective sub-threshold current suppression in nDMOS1 at 200 kHz for M=800.

FIG. 13 shows a plot of the power efficiency of a synchronous rectifier according to an embodiment for different chip sizes and switching frequencies.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting of only components A and B. It means that with respect to the present invention, the only relevant components of the device are A and B.

In order to reduce the dynamic power losses in the bipolar transistors, as described above, a synchronous rectifier architecture is proposed, in which the charging of the DMOS gate capacitance is no longer done directly from the pulse transformer's output node. Rather such charging is done from an auxiliary supply voltage which is better suited than the input voltage.

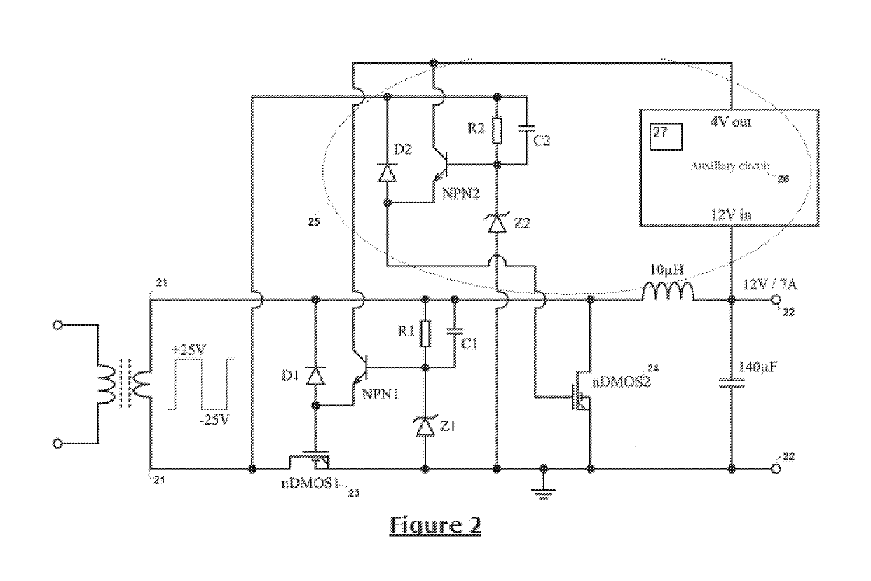

FIG. 2 shows a version of a synchronous rectifier circuit according to an embodiment of the invention. In particular, FIG. 2 illustrates a circuit for converting a pulsed input voltage to a DC output voltage. The circuit is shown comprising input nodes 21 for receiving the pulsed input voltage, and output nodes 22 for outputting the DC output voltage.

The circuit is shown further comprising a first transistor 23 (nDMOS1) and a second transistor 24 (nDMOS2). The first and second transistors 23, 24 each have a threshold voltage, and are connected between the input and the output nodes in a synchronous rectifier configuration, meaning each of the first and second transistors is in parallel with a diode. Additionally, the first and second transistors 23, 24 each have a gate connected to a driving circuit 25 configured for alternately charging the gates of the transistors. The driving circuit 25 comprises an auxiliary circuit 26. Auxiliary circuit 26 is decoupled from (that is, is not directly connected to) the input nodes, and is configured for providing a predetermined auxiliary supply voltage.

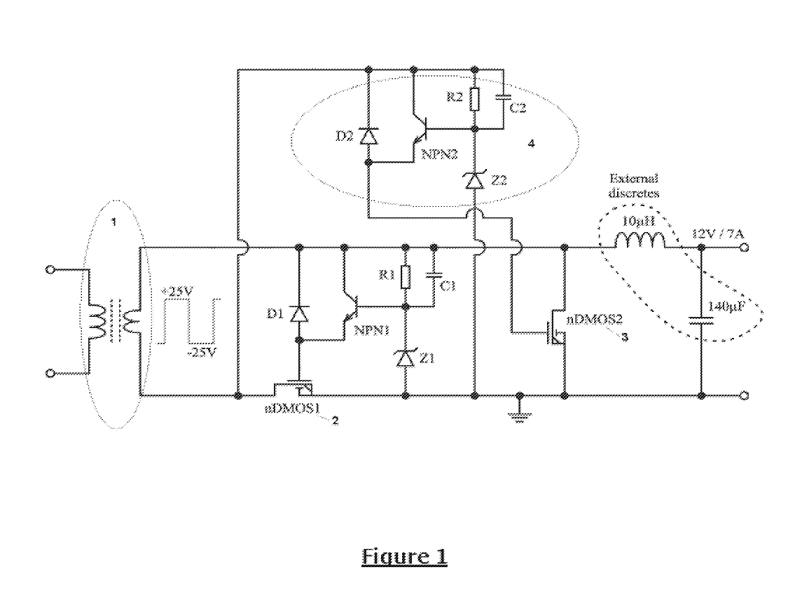

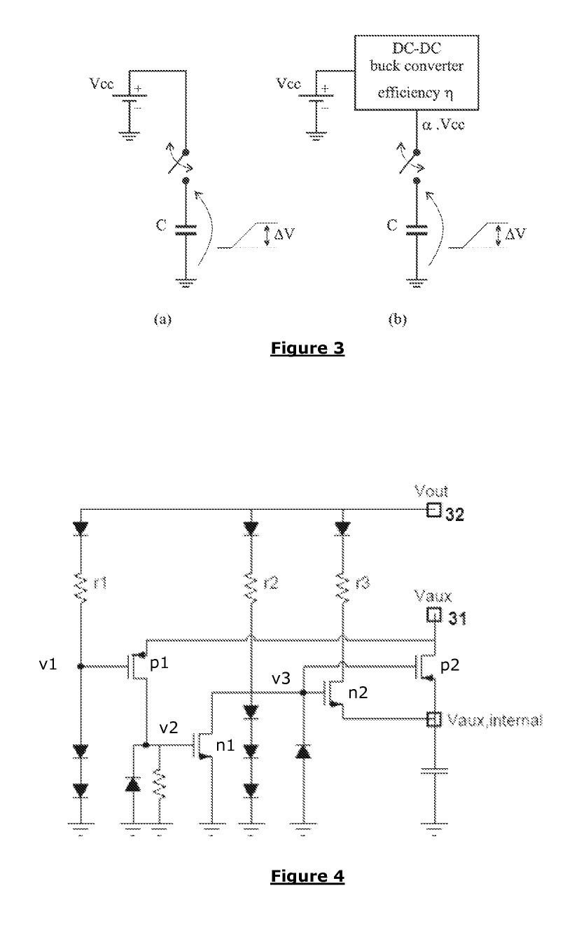

For the circuit shown in FIG. 2, the main dynamic losses of energy result from the charging and discharging of the switching transistors' gate capacitance. Charging of the gate capacitance by NPN bipolar transistors, as discussed above with respect to FIG. 1, is very inefficient. As shown, the gates of the transistors are charged through the NPN devices from a high power supply (the voltage across the secondary winding of the pulse transformer, shown to be 25V). From an energetic point of view, this is a very bad strategy. To illustrate this and a means for considerable improvement, FIG. 3 may be considered.

FIG. 3 illustrates the principle of dynamic power loss reduction. Two circuits are shown in FIG. 3.

In circuit (a), the capacitor C is charged an amount ΔV from a much higher supply voltage V_{cc} through some solid-state switch. A very simple calculation shows that the corresponding energy ΔE delivered by the supply voltage V_{cc} is given by:

ΔE=C·V_{cc}·ΔV

Circuit (b) is identical to circuit (a) except that a power-efficient auxiliary circuit having a high efficiency η has been added between the supply voltage V_{cc} and the capacitor C. In circuit (b), as a result of the auxiliary circuit, the supply voltage V_{cc} is first down-converted to a level α * V_{cc} slightly above the needed range ΔV. In this case, the energy delivered by the source V_{cc} will be given by:

$$Δ E = \frac{α \cdot C \cdot {V}_{cc} \cdot Δ V}{η}$$

Thus, this approach serves to boost the power efficiency of the synchronous rectifier circuit at high switching frequencies (e.g 300 kHz to 5 MHz) or for transistors with gate capacitances greater than a few nF. The main source of the increase in efficiency is the addition of the power-efficient auxiliary circuit. In such a synchronous rectifier circuit, the auxiliary supply voltage is not directly derived from the transformer voltage, but rather from the auxiliary circuit instead. The auxiliary circuit may be powered by either an independent power source or by the output voltage of the synchronous rectifier itself.

As noted above, the main dynamic losses of a synchronous rectifier result from the charging and discharging of the switching transistors' gate capacitance, and thus are based at least in part on the gate-source voltage ΔV. Furthermore, the conductive losses of the synchronous rectifier are similarly dependent on the characteristics of the switching transistors and on the gate-source voltage ΔV.

Therefore both dynamic and conductive losses are linked to ΔV, and thus to the auxiliary supply voltage. In an embodiment, the auxiliary supply voltage may be fixed, such as when the auxiliary circuit is powered using the output voltage (given the output voltage is adequate).

Depending on the load current, frequency, temperature and other parameters, however, the voltage ΔV that minimizes the overall loss may vary. Accordingly, it may be desirable to identify the voltage ΔV that minimizes the overall loss. In order to do so, a control block 27, as shown in FIG. 2, can be implemented within the auxiliary circuit. In particular, the auxiliary supply voltage may be controlled by the control block 27 based the relevant parameters (load current, frequency, temperature, etc.). Thus, the auxiliary supply voltage may be parameter-dependent rather than fixed.

In the event the auxiliary supply voltage is parameter-dependent, the auxiliary circuit may be powered by an auxiliary power supply, such as a buck or boost converter. The auxiliary power supply may be an independent power supply and simply present at start up (power-on phase). The output voltage of the auxiliary power supply can be controlled, either manually or via the control block 27.

If independent auxiliary power supply is not present during power-on, or if the auxiliary power supply is also dependent on the input voltage of the synchronous rectifier (e.g. from a separate transformer winding or derived from the synchronous rectifier's output), there is a possibility that the auxiliary DC supply voltage may be too low.

Normally this power-on phase only takes a very short time. As soon as the auxiliary supply voltage has reached a stable value, the DMOS devices start to act as almost ideal rectifying diodes with extremely low conductive power dissipation in the on-state.

The synchronous rectifier may rely entirely on the built-in drain-bulk diode of the DMOS devices for the signal rectification. Alternately, in an embodiment, the auxiliary voltage may further comprise a power-on backup. During the power-on phase, the dissipation will not be too high for the integrated circuit.

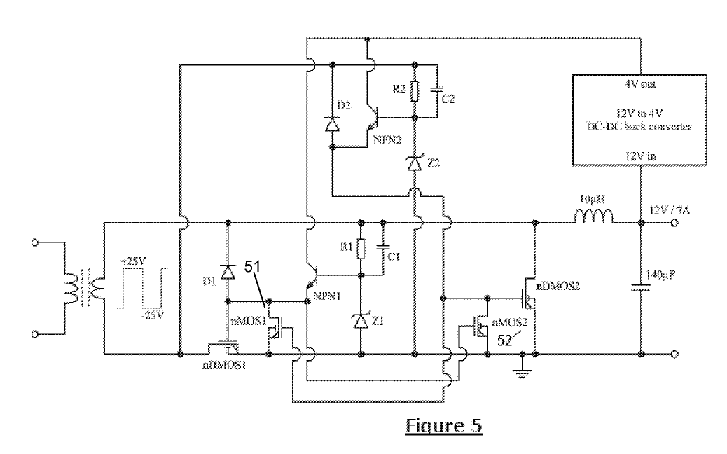

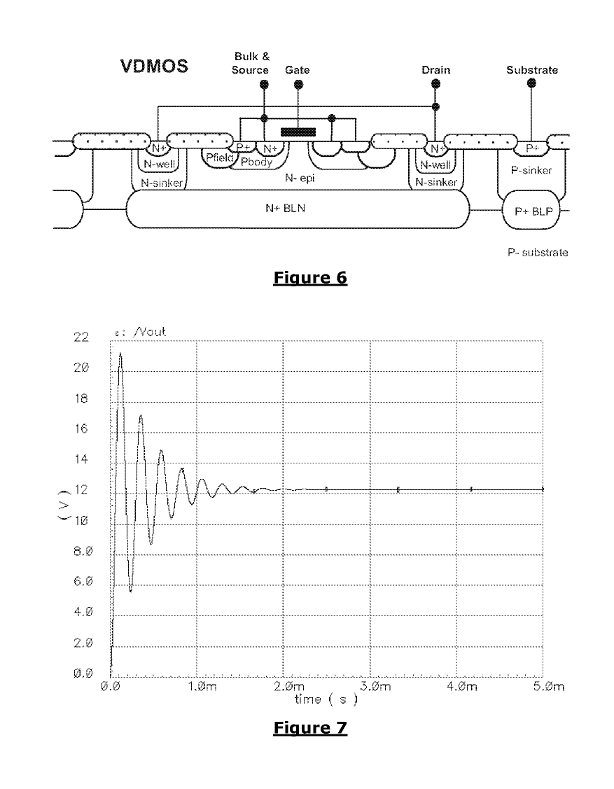

In an embodiment, the power-on backup voltage is also derived from the output voltage, which has lower efficiency but kicks in as soon as the output voltage starts increasing. Once the auxiliary supply voltage is available, the power-on backup can be switched off. A possible implementation of a power-on backup circuit is illustrated in FIG. 4.

FIG. 4 shows a power-on backup circuit. As shown, the power-on back up circuit comprises an auxiliary voltage (Vₐᵤₓ) node 31 and an output voltage (Vₒᵤₜ) node 32. The Vₐᵤₓ node 31 is decoupled by a large capacitor to buffer the peak currents occurring at switching times. In the proposed circuit, both the backup power-on supply and the steady state auxiliary supply voltage (Vₐᵤₓ) use the same decoupling capacitor, reducing the number of external components.

At startup, Vₐᵤₓ will be low and a pDMOS transistor p1 (as shown in FIG. 4) will be off. As voltage Vₒᵤₜ at the Vₒᵤₜ node 32 rises, voltage v1 will rise too, but p1 will remain off. Therefore, voltage v2 will be pulled to ground and voltage v3 will rise with Vₒᵤₜ to the threshold defined by the diodes. This will switch on nDMOS transistor n2 and switch off pDMOS transistor p2.

Note that p2 is used in reverse to avoid discharging of the decoupling capacitor through its bulk-drain diode. While n2 is on, the capacitor will be charged and Vₒᵤₜ will provide a fast auxiliary supply voltage. When Vₐᵤₓ rises above v1, p1 will be activated. Then the gate of n1 will be pulled high and, as a result, n1 will pull v3 to the ground, switching on p2 and switching off n2.

In this manner the backup power-on supply voltage is effectively OR-ed from Vₐᵤₓ at all times. Loss of a diode voltage drop is prevented through the use of an active switch, p2. Such prevention is important, especially for instances in which Vₐᵤₓ is low. Note that the OR-ing to Vₐᵤₓ close to the IC is preferred, otherwise the whole capacitive load of the V. PCB node would have to be charged by the backup power-on supply.

When the backup power-on supply is on, the dissipation is given by:

Dissipation=(Vₒᵤₜ−V_{aux, internal})·I_{average}

The current drawn by the synchronous rectifier is used to charge the transistors' gates and given by:

$${I}_{average} = \frac{2 \cdot {C}_{gate} \cdot {V}_{aux , internal}}{{T}_{synchr}}$$

As an example, for about 150 basic cells (M=150), C_{gate}≈16.8 nF. For 1 Mhz switching frequency and V_{aux, internal}=3.3V, we find an average current of approximately 110 mA, which yields a dissipation of≈1 W. For higher frequencies the average current increases very fast. An external resistor, such as r₃ in FIG. 4, can be used, lowering the IC dissipation.

When Vₐᵤₓ reaches a satisfactory level, the backup power-on supply will be switched off and the only dissipation left will be through r₁ and r₂. The resistances of r₁ and r₂ can be chosen much higher than that of r₃ such that the static power dissipation is very low. As an example, the static power dissipation may be on the order of 1 mW.

FIG. 5 illustrates an embodiment of a synchronous rectifier with reduced dynamic power losses and suppressed sub-threshold conduction according to the invention. In some embodiments, two MOS transistors 51, 52 may be added that completely discharge the gate electrode of the two power DMOS devices to zero volts to switch them off. The problem of sub-threshold conduction in the off-state is hereby solved.

As the two DMOS devices are driven in a complementary way, the gate voltage of one DMOS device may be used to activate the MOS transistor in order to discharge the gate electrode of the other DMOS device. Alternately, the MOS discharge transistor may be driven independently of the DMOS devices.

For example a buffered driving of the DMOS gate electrode via an inverter will result in a MOS discharging the gate and reducing sub-threshold currents. However this buffer can be driven from any logic signal, derived from any signal thought suitable or even created especially for this purpose. Adding a discharging MOS can substantially eliminate the sub-threshold conduction of the DMOS devices in the off-state and reduce the static power dissipation in the off-state to a negligible level.

### Implementation Example

An example implementation of the invention is described. The following list explains which devices have been selected in an 80V, 0.35 m smart-power technology and what device parameters (mainly dimensions) have been used in the simulations and as illustrated in FIG. 1:
nDMOS1, nDMOS2: an 80V vertical floating n-type DMOS transistor. These transistors are actually formed as the parallel connection of a number M (a parameter called the Multiplier in the device model, and treated as a design variable in this exercise) basic unit cells. Each unit cell consists of 16 parallel channels, each 500 μm wide, that are flanked by a drain plug to the n-type buried layer on both sides of the structure. This configuration consisting of M parallel unit cells of 16 parallel channels each actually yields the minimum specific on-state resistance of the device. For a smaller number of parallel channels in a unit cell, the drain overhead (“wasted” silicon area on both sides of the unit cell) deteriorates the specific on-state resistance. For a larger number of parallel channels in a unit cell, the extra series resistance in the n-type buried layer degrades the device performance. In this optimal configuration, both nDMOS1 and nDMOS2 transistors feature the following characteristics:
   Total channel width=M * 8 mm
   Silicon area=M * 0.054 mm²
   On-state resistance, Rₒₙ=4.55 S2/M
   Specific on-state resistance Rₒₙ* area=246 mΩmm²
NPN1, NPN2: These NPN transistors, with a typical current gain in the range from 50 to 100 for the current levels used in this circuit, are formed as the parallel connection of 100 basic unit cells, where each unit cell has an active emitter area of 7 * 7 μm² (these dimensions are imposed by the technology itself). The NPN1 and NPN2 transistors have a silicon area of 0.46 mm² each.
D1, D2: an 80V PN junction diode. Both components consist of 20 elementary diodes connected in parallel, where each elementary diode has an active junction area of 2.6 μm long (imposed by the technology) and 200 μm wide. The D1 and D2 diodes have a silicon area of 0.57 mm² each.
Z1, Z2: These components are not really Zener diodes, but rather a chain of five normally biased diodes connected in series, thereby yielding an equivalent “Zener voltage” of five diode threshold voltages (≈4V in total). In such a chain, each diode is actually formed as two elementary cells in parallel, each elementary cell having an active junction area of 2.6 μm * 200 μm. Both Z1 and Z2 components have a silicon area of 0.29 mm² each.
R1, R2: highly Ohmic poly-silicon resistors of 2 kΩ). The required silicon area is negligible.
C1, C2: metal 2-metal 2.5 capacitors of 200 pF. Each capacitor needs about 0.13 mm² silicon area.

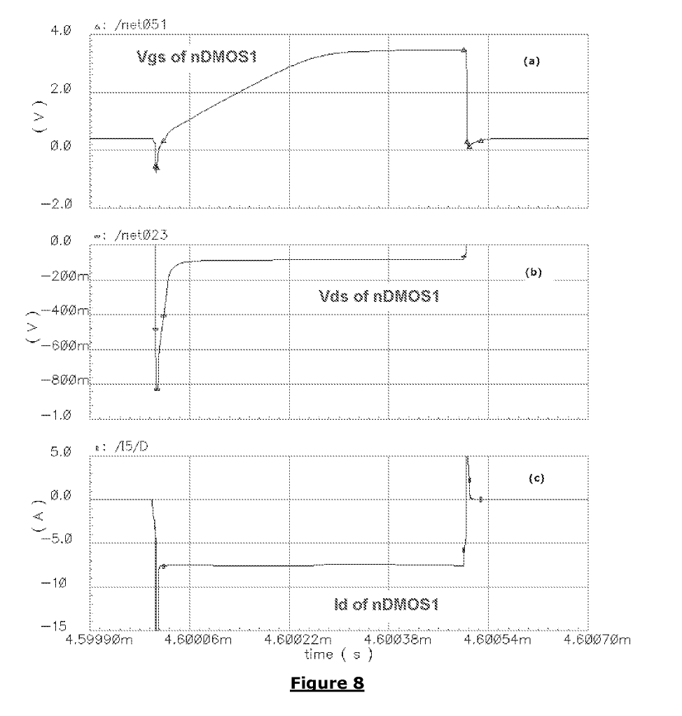

FIG. 7 illustrates a typical output voltage of the synchronous rectifier after start-up. The synchronous rectifier may comprise a 1.75Ω load resistor. This simulation reveals a strong transient (that is, overshoot and damped oscillation) until about 2.5 ms after start-up, as can be seen by the oscillations that continue until about 2.5 ms after start-up. All other signals exhibit a very similar behavior during the same time interval.

As what is at issue is the power efficiency of the synchronous rectifier under steady-state conditions, the simulation of FIG. 7 suggests that one consider the signals from 2.5 ms onwards only. Accordingly, power efficiency was calculated on the basis of the average input and output power by monitoring the accumulated energy (delivered by the pulse transformer at the input of the circuit and consumed by the 1.75Ω load resistor at the output) during the time interval [3 ms, 5 ms], and dividing this accumulated energy by the total interval duration of 2 ms.

FIG. 8 shows simulation results of the (a) source-gate voltage, (b) source-drain voltage and (c) the drain current of the nDMOS1 transistor during turn-on in steady-state circumstances at 1 MHz for M=400. At the beginning of the pulse, the load current of approximately 7 A is flowing entirely through the built-in drain-bulk diode of the device, yielding a source-drain voltage of about −0.8V.

At the same time, the gate capacitance is being charged through the NPN1 transistor, and the conducting channel is rapidly taking over all current from the built-in drain-bulk diode. Very soon, the source-drain voltage reaches a stable level of only −80 mV (this level is inversely proportional to the design variable M, indicating the number of cells), resulting in a very low static power dissipation in the device. The contribution of the −0.8V peak in the power dissipation of nDMOS1 is rather small (especially at moderate values of M and the switching frequency) thanks to the presence of capacitor C1 and the large bipolar transistor NPN1 as they keep the −0.8V peak duration very short. For nDMOS2, almost identical curves are obtained.

Table 1 shows how the simulated power efficiency of the synchronous rectifier depends on the channel width of the nDMOS1 and nDMOS2 transistors and the switching frequency.

TABLE 1
Simulated power efficiency of the basic synchronous rectifier for
different nDMOS sizes and switching frequencies.

| Multiplier M | Power efficiency (%) | | | |
|---|---|---|---|---|
| nDMOS | @ 200 kHz | @ 400 kHz | @ 600 kHz | @ 1 MHz |
| 25 | 92.5 | 92.3 | 92.1 | 91.9 |
| 50 | 94.7 | 94.6 | 94.4 | 94.0 |
| 100 | 96.9 | 96.7 | 96.4 | 95.5 |
| 150 | 97.6 | 97.4 | 96.5 | 95.3 |
| 200 | 97.8 | 97.5 | 96.1 | 94.6 |
| 300 | 97.7 | 97.1 | 95.1 | 92.9 |
| 400 | 97.4 | 96.5 | 94.2 | 91.1 |
| 800 | 96.1 | 93.5 | 90.1 | 84.4 |

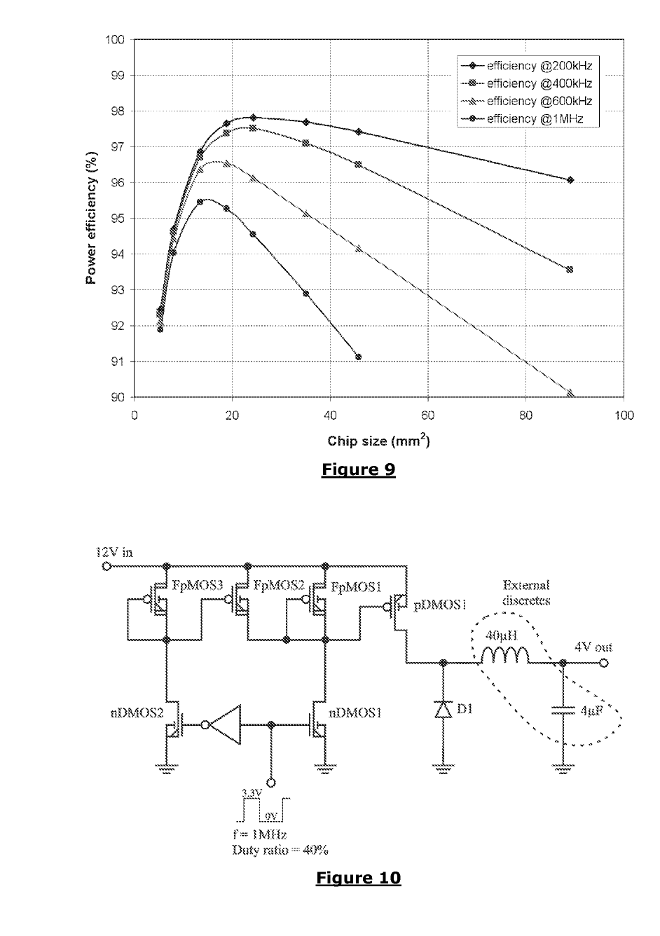

FIG. 9 shows a plot of the power efficiency of the synchronous rectifier of FIG. 1 for different chip sizes and switching frequencies. In particular, FIG. 9 shows the information of Table 1 in a graphical format, with the nDMOS1 and nDMOS2 channel width has been converted into the total chip area. Note that this chip area contains the contribution of all active and passive components on the die, but not the silicon area needed for the bonding pads and interconnection (mainly between the nDMOS source and drain electrodes and the bonding pads).

As seen from FIG. 9, initially the power efficiency rises steeply for increasing values of the nDMOS channel width because the channel resistance, and hence also the static power dissipation in the nDMOS, are inversely proportional to the channel width. However, as the channel width goes up, the gate capacitance of the nDMOS also increases, thereby requiring more power in the NPN transistors to constantly charge this gate capacitance at the switching rate.

At a certain critical value of the channel width, this dynamic dissipation in the NPN devices becomes more important than the static dissipation in the nDMOS devices, and from that point on, the power efficiency begins to drop. The higher the switching frequency, the sooner this critical point is reached (because the dynamic losses in the NPN transistors are proportional to the switching frequency), and the more steeply the curve will drop.

The contribution of the static dissipation in the nDMOS and dynamic dissipation in the NPN devices is also clear from Table 2. For rather small values of the nDMOS channel width in combination with a moderate switching frequency, the static nDMOS dissipation is predominant. For very wide nDMOS channels and/or high switching frequencies, the dynamic NPN dissipation has the main impact on power efficiency.

TABLE 2
Contribution of different transistors in the total power dissipation for
different nDMOS sizes and switching frequencies.

| | Average power dissipation (mW) | | |
|---|---|---|---|
| | M_nDMOS = 100 | M_nDMOS = 800 | M_nDMOS = 200 |
| Component | @ 200 kHz | @ 200 kHz | @ 1 MHz |
| nDMOS1 | 1120 | 360 | 890 |
| nDMOS2 | 1130 | 460 | 910 |
| NPN1 | 70 | 1240 | 1540 |
| NPN2 | 70 | 1240 | 1530 |

A conclusion may be drawn from Table 2, which is: in order to improve the power efficiency of the synchronous rectifier at high switching frequencies, the dynamic power losses in the NPN transistors ought to be reduced without deteriorating the static losses in the nDMOS devices. In other words, what is needed is a circuit solution that reduces the energy needed to charge the gate capacitance of the nDMOS devices without actually reducing the size of these devices.
Synchronous Rectifier with Reduced Dynamic Power Losses:

Returning to FIG. 3, in circuit (a), it was noted that the capacitor was charged an amount ΔV from a much higher supply voltage V_{cc} through some solid-state switch. For example, if ΔV is 3.5V, V_{cc} may be 25V, and the switch may be an NPN bipolar transistor.

In circuit (b), however, it was noted that the supply voltage V_{cc} may be first down-converted to a level α * V_{cc} slightly above the needed range ΔV, e.g. α * V_{cc}=4V. Such down-converting may be done by means of an auxiliary circuit having an efficiency η (e.g., 80%). Accordingly, the energy consumption of circuit (b) is significantly less (e.g., 5 times less) than that of circuit (a).

Thus, the addition of an auxiliary circuit may significantly reduce the energy consumption of the circuit. An example of such an auxiliary circuit is a DC-DC buck converter.

FIG. 10 shows a schematic of a 12V to 4V buck converter. Transistor pDMOS1 is the main switch in this buck converter, while the other transistors form a level-shifter for driving the gate electrode of the main switch. The voltage mirror nDMOS1+FpMOS1, where nDMOS1 is driven by a 1 MHz clock signal with 40% duty ratio and FpMOS1 acts as an active load, directly controls the source-gate voltage of pDMOS1. The additional voltage mirror nDMOS2+FpMOS3, driven by the complementary clock signal, in combination with FpMOS2, effectively discharges the gate capacitance of pDMOS1 in order to avoid leakage current in the switch during the off-state. Example transistor types and dimensions are as follows:
pDMOS1: an 80V lateral floating pDMOS. It consists of 20 basic unit cells, each having a single channel of 500 μm wide.
nDMOS1, nDMOS2: an 80V vertical floating nDMOS.
   nDMOS1 has 2 parallel channels of 40 μm wide
   nDMOS2 has 2 parallel channels of 10 μm wide
FpMOS1, FpMOS2, FpMOS3: a floating low-voltage pMOS.
   FpMOS1 has a single channel, 0.35 μm long and 30 μm wide
   FpMOS2 has a single channel, 0.35 μm long and 100 μm wide
   FpMOS3 has a single channel, 0.35 μm long and 10 μm wide

The circuit of FIG. 10 converts the 12V into 4V at approximately 80% power efficiency for the output current levels that are needed to drive the 2 NPN bipolar transistors in the synchronous rectifier shown in FIG. 2.

The reduction in the dynamic switching losses resulting from this technique is evidenced by the simulated data in Table 3. Whereas previously the dynamic losses in the NPN devices were predominant in the power consumption of the original circuit (often for very large nDMOS devices or high switching frequencies), the introduction of this new technique makes the dynamic losses in the NPN devices only marginal compared to the static losses in the nDMOS transistors. Note that the average additional power consumption of the active components in the 12V to 4V DC-DC buck converter is about 170 mW in the simulations of Table 3.

TABLE 3
Impact of dynamic loss reduction on transistor power dissipation and
global power efficiency.

| | Average power dissipation (mW) | | | |
|---|---|---|---|---|
| | M nDMOS = 800, | | M nDMOS = 200, | |
| | @ 200 kHz | | @ 1 MHz | |
| | Basic | Improved | Basic | Improved |
| Component | circuit | circuit | circuit | circuit |
| nDMOS1 | 360 | 370 | 890 | 850 |
| nDMOS2 | 460 | 510 | 910 | 860 |
| NPN1 | 1240 | 160 | 1540 | 180 |
| NPN2 | 1240 | 160 | 1530 | 180 |
| Global power | 96.1% | 98.1% | 94.6% | 97.0% |
| efficiency | | | | |

The power efficiency can improve even more by focusing on reducing the static dissipation in the nDMOS transistors. Thorough investigation of the nDMOS behavior shows that the nDMOS is dissipating as much power during the off-state as during the on-state. The cause can be found in unexpected sub-threshold conduction of the nDMOS. Indeed, when nDMOS2 is activated (acting as freewheeling diode for the load current), its drain potential reaches a value of typically 50 to 100 mV below ground (depending on the actual channel width). As a consequence, the gate electrode of nDMOS1 is discharged through diode D1 to a level at one diode threshold above the drain potential of nDMOS2.

In other words, the gate of nDMOS1 is not entirely discharged to ground but rather to a level of approximately 0.4V. This is only slightly below the threshold voltage, which is typically 0.5V for the chosen transistor type. Due to the very wide transistor channel, this gate voltage triggers a considerable sub-threshold current of the order of several milliamps. As the source-drain voltage of nDMOS1 is roughly 25V at that moment, this sub-threshold current can easily cause a static power dissipation of several hundreds of milliwatts, comparable to the static power consumption during the on-state of the device (when the drain current is much higher, around 7 A, and the drain voltage much lower, somewhere in the range from 50 to 100 mV).

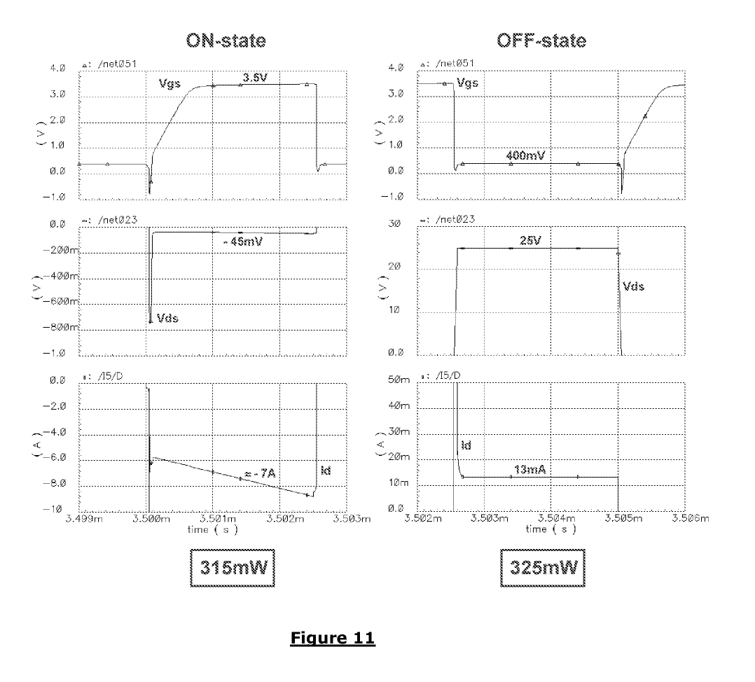

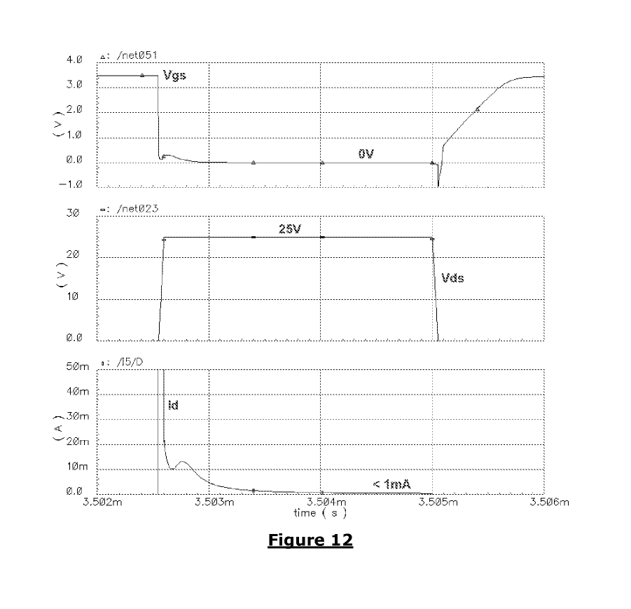

FIG. 11 illustrates the impact of nDMOS sub-threshold conduction on the power dissipation at 200 kHz for M=800. It can be seen from FIG. 11 that the static dissipation in the off-state of the nDMOS can indeed be as large as during the on-state of the device.

Synchronous Rectifier with Reduced Dynamic Power Losses and Suppressed Sub-Threshold Conduction:

As the two transistors operate in a complementary way, such that one is turned off while the other is turned on, the gate signal of one nDMOS can be used to discharge the gate electrode of the other, simply by adding a pair of small low-voltage nMOS transistors, resulting in the embodiment shown in FIG. 5.

When nDMOS2 is activated, as a result of its gate being charged to about 3.5V, the additional transistor nMOS1 will be turned on, resulting in the complete discharging of the gate electrode of nDMOS1. The same occurs with nDMOS2 and nDMOS1 in the opposite roles. The two extra devices nMOS1 and nMOS2 are for example standard low-voltage nMOS transistors, having a single channel of 0.35 μm long and 100 μm wide.

FIG. 12 shows a simulation of effective sub-threshold current suppression in nDMOS1 at 200 kHz for M=800. From FIG. 12, one can see that the gate electrode of the nDMOS may now completely discharge to approximately 0V instead of sticking at a 0.4V level, as with the previous design (as shown in FIG. 11). Additionally, it can be seen that the corresponding drain current has dropped to less than 1 mA instead of the 13 mA in the simulations of FIG. 11.

Table 4 shows the impact of this technique on the power consumption of the individual transistors and the global power efficiency. The static power dissipation in the nDMOS devices has dropped significantly, in particular in the off-state. Table 5 represents the simulated global power efficiency of the synchronous rectifier in FIG. 5 for different nDMOS channel dimensions and switching frequencies.

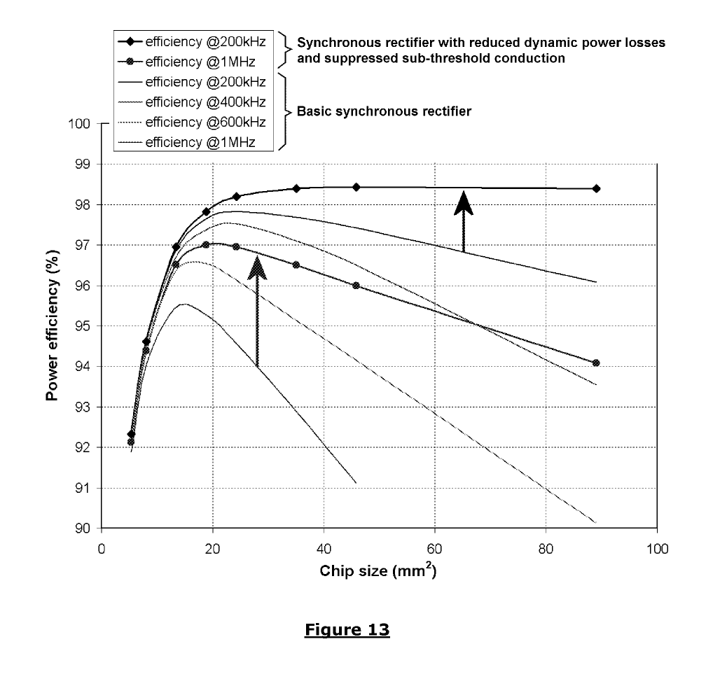

FIG. 13 shows a plot of the power efficiency of a synchronous rectifier according to an embodiment for different chip sizes and switching frequencies. In particular, the information from Table 5, where the nDMOS channel dimensions have been converted into the corresponding chip size, is gathered in a graphical way in FIG. 13. This graph also contains the data from the original circuit in FIG. 1. A comparison reveals the superior performance of the circuit from FIG. 5. When looking at a switching frequency of 1 MHz, the original circuit yielded a maximum power efficiency of 95.5%, whereas the introduction of the techniques for dynamic power loss reduction and suppression of sub-threshold conduction boosts the power efficiency to 97.0%. At frequencies above 1 MHz, the power efficiency increase would be even more pronounced.

TABLE 4
Impact of sub-threshold current suppression on transistor power
dissipation and global power efficiency.

| | Average power dissipation (mW) | |
|---|---|---|
| | M_nDMOS = 800, @ 200 kHz | |
| | Without sub-threshold | With sub-threshold |
| Component | current suppression | current suppression |
| nDMOS1 | 370 | 250 |
| nDMOS2 | 510 | 270 |
| NPN1 | 160 | 160 |
| NPN2 | 160 | 160 |
| Global power | 98.1 | 98.4 |
| efficiency | | |

TABLE 5
Simulated power efficiency of the synchronous rectifier
with reduced dynamic power losses and suppressed
sub-threshold conduction for different nDMOS
sizes and switching frequencies.

| Multiplier M | Power efficiency (%) | |
|---|---|---|
| nDMOS | @ 200 kHz | @ 1 MHz |
| 25 | 92.3 | 92.1 |
| 50 | 94.6 | 94.4 |
| 100 | 97.0 | 96.5 |
| 150 | 97.8 | 97.0 |
| 200 | 98.2 | 97.0 |
| 300 | 98.4 | 96.5 |
| 400 | 98.4 | 96.0 |
| 800 | 98.4 | 94.1 |

1. A voltage converter circuit comprising:
at least two input nodes arranged to receive a pulsed input voltage;
at least two output nodes arranged to output a DC output voltage;
a first transistor having a first gate, wherein the first transistor is connected between the at least two input nodes and the at least two output nodes;
a second transistor having a second gate, wherein the second transistor is connected between the at least two input nodes and the at least two output nodes; and
a driving circuit connected to the first gate and the second gate, the driving circuit being arranged to alternately charge the first gate and the second gate, wherein the driving circuit comprises an auxiliary circuit arranged to provide a predetermined auxiliary supply voltage to the first gate and the second gate.

2. The circuit according to claim 1, wherein the first and second transistors each have a threshold voltage.

3. The circuit according to claim 2, wherein the predetermined auxiliary supply voltage is between 2 and 10 times the threshold voltage.

4. The circuit according to claim 1, wherein the auxiliary circuit is not directly connected to the at least two input nodes.

5. The circuit according to claim 1, wherein the auxiliary circuit is powered by an independent power source.

6. The circuit according to claim 1, wherein the auxiliary circuit is powered by the output voltage.

7. The circuit according to claim 6, wherein the auxiliary circuit comprises an auxiliary input node connected to the at least two output nodes.

8. The circuit according to claim 1, wherein the auxiliary circuit comprises an auxiliary output node connected to the first gate and the second gate.

9. The circuit according to claim 1, wherein the auxiliary circuit is a buck DC-DC converter.

10. The circuit according to claim 1, wherein the first and second transistors are double-diffused metal-oxide-semiconductor (DMOS) transistors.

11. The circuit according to claim 1, further comprising a control block operable to control the auxiliary supply voltage based on at least one input parameter.

12. The circuit according to claim 11, wherein the at least one input parameter comprises one or more of a current, a frequency, and a temperature.

13. The circuit according to claim 1, further comprising a back-up circuit operable to power on the auxiliary circuit at start-up.

14. The circuit according to claim 1, wherein the first gate and the second gate are each grounded via at least one gate discharging transistor.

15. The circuit according to claim 14, wherein the at least one gate discharging transistor comprises (i) a first gate discharging transistor controlled by the first transistor and operable to discharge the second gate, and (ii) a second gate discharging transistor controlled by the second transistor and operable to discharge the first gate.

16. The circuit according to claim 15, wherein discharging the second gate comprises discharging the second gate during an off-state of the second transistor, and discharging the first gate comprises discharging the first gate during an off-state of the first transistor.

17. The circuit according to claim 14, wherein the gate discharging transistors are driven via a buffer.

18. A voltage converter comprising:
a primary circuit arranged to receive a first voltage;
a secondary circuit arranged to receive a pulsed input voltage, the secondary circuit comprising a first transistor having a first gate and a second transistor having a second gate;
a pulse transformer comprising a primary winding and a second winding, wherein the primary winding is connected to the primary circuit, the secondary winding is connected to the secondary circuit, and the pulse transformer is arranged to transform the first voltage into the pulsed input voltage; and
a driving circuit connected to the first gate and the second gate, the driving circuit being arranged to alternately charge the first gate and the second gate by means of an auxiliary supply voltage.

19. The circuit according to claim 18, wherein the first voltage is one of (i) a DC voltage that is a higher voltage than the DC output voltage and (ii) an AC voltage.

20. The circuit according to claim 18, wherein the primary circuit and the secondary circuit are monolithic integrated circuits.
